(19) United States
(12) Patent Application Publication
(10) Pub. No.: US 2010/0309292 A1
(43) Pub. Date: Dec. 9, 2010

(54) METHOD AND APPARATUS FOR GENERATING MULTI-VIEWPOINT DEPTH MAP, METHOD FOR GENERATING DISPARITY OF MULTI-VIEWPOINT IMAGE

(75) Inventors: Yo-Sung HO, Gwangju (KR); Eun-Kyung Lee, Gwangju (KR); Sung-Yeol Kim, Gwangju (KR)

Correspondence Address: AMPACC Law Group, 3500 188th Street S.W., Suite 103, Lynnwood, WA, 98037, US

(73) Assignees: Gwangju Institute of Science and Technology, Gwangju (KR); KT Corporation, Kyeonggi-do (KR)

(21) Appl. No.: 12/745,099

(22) PCT Filed: Nov. 28, 2008
(86) PCT No.: PCT/KR2008/007027

§ 371 Date: May 27, 2010

(30) Foreign Application Priority Data
Nov. 29, 2007 (KR) 10 2007 0122629

(51) Int. Cl. H04N 13/02; G06K 9/00

(52) U.S. Cl. 348/47; 382/154; 348/E13.074

(57) ABSTRACT

There are provided a method and an apparatus for generating a multi-viewpoint depth map, and a method for generating a disparity of a multi-viewpoint image. A method for generating a multi-viewpoint depth map according to the present invention includes the steps of: (a) acquiring a multi-viewpoint image constituted by a plurality of images by using a plurality of cameras (b) acquiring an image and depth information by using a depth camera; (c) estimating coordinates of the same point in a space in the plurality of images by using the acquired depth information; (d) determining disparities in the plurality of images with respect to in the same point by searching a predetermined region around the estimated coordinates; and (e) generating a multi-viewpoint depth map by using the determined disparities. According to the above-mentioned present invention, it is possible to generate a multi-viewpoint depth map within a shorter time and generate a multi-viewpoint depth map having higher quality than a multi-viewpoint depth map generated by using known stereo matching.

### TECHNICAL FIELD

The present invention relates to a method and an apparatus for generating a multi-viewpoint depth map and a method for generating a disparity of a multi-viewpoint image, and more particularly, to a method and an apparatus for generating a multi-viewpoint depth map that are capable of generating a high-quality multi-viewpoint depth map within a short time by using depth information acquired by a depth camera and a method for generating a disparity of a multi-viewpoint image.

### BACKGROUND ART

A method for acquiring three-dimensional information from a subject is classified into a passive method and an active method. The active method includes a method using a three-dimensional scanner, a method using a structured ray pattern, and a method using a depth camera. In this case, although the three-dimensional information can be, in real time, acquired in comparative precision, equipments are high-priced and equipments other than the depth camera are not capable of modeling a dynamic object or a scene.

Examples of the passive method include a stereo-matching method using a stereoscopic stereo image, a silhouette-based method, a voxel coloring method which is a volume-based modeling method, a motion-based shape estimating method of calculating three-dimensional information on a multi-viewpoint static object photographed by movement of a camera, and a shape estimating method using shade information.

In particular, the stereo-matching method, as a technique used for acquiring a three-dimensional image from a stereo image, is used for acquiring the three-dimensional image from a plurality of two-dimensional images photographed at different positions on the same line with respect to the same subject. As such, the stereo image represents the plurality of two-dimensional images photographed at different positions with respect to the subject, that is, the plurality of two-dimensional images that have pair relations each other.

In general, a coordinate z which is depth information is required to generate the three-dimensional image from the two-dimensional images in addition to coordinates x and y which are vertical and horizontal positional information of the two-dimensional images. Disparity information of the stereo image is required to determine the coordinate z. The stereo matching is used a technique used for acquiring the disparity. For example, when the stereo image is left and right images photographed by two left and right cameras, one of the left and right images is set to a reference image and the other is set to a search image. In this case, a distance between the reference image and the search image with respect to the one same point in a space, that is, a difference in a coordinate represents the disparity. The disparity is determined by using the stereo matching technique.

Such a passive method is capable of generating the three-dimensional information by using the images acquired multi-viewpoint optical cameras. This passive method has advantages in that the three-dimensional information can be acquired at lower cost and resolution is higher than the active method. However, the passive method has disadvantages in that it takes a long time to calculate the three-dimensional information and the passive method is lower than the active method in accuracy of the depth information due to images characteristics, i.e., a change in a lighting condition, a texture, and the existence of a shielding region.

### DISCLOSURE

### Technical Problem

It is an object of the present invention to provide a method and an apparatus for generating a multi-viewpoint depth map, which can generate the multi-viewpoint depth map within a shorter time and generate a multi-viewpoint depth map having higher quality than a multi-viewpoint depth map generated by using known stereo matching.

### Technical Solution

In order to solve a first problem, a method for generating a multi-viewpoint depth map according to the present invention includes the steps of: (a) acquiring a multi-viewpoint image constituted by a plurality of images by using a plurality of cameras; (b) acquiring an image and depth information by using a depth camera; (c) estimating coordinates of the same point in a space in the plurality of images by using the acquired depth information; (d) determining disparities in the plurality of images with respect to in the same point by searching a predetermined region around the estimated coordinates; and (e) generating a multi-viewpoint depth map by using the determined disparities.

Herein, in the step (b), the disparities in the plurality of images with respect to the same point in the space may be estimated from the acquired depth information and the coordinates may be acquired depending on the estimated disparities. At this time, the disparities are estimated by the following equation. Herein, dₓ is the disparity, f is a focus distance of a corresponding camera among the plurality of cameras, B is a gap between the corresponding camera and the depth camera, and Z is the depth information.

$${d}_{x} = \frac{fB}{Z} .$$

Further, the step (d) may include the steps of: (d1) establishing a window having a predetermined size, which corresponds to the coordinate with respect to the same point in the image, which is acquired by the depth camera; (d2) acquiring similarities between pixels included in the window having the predetermined size and pixels included in windows having the same size in the predetermined region; and (d3) determining the disparities by using the coordinates of the pixels corresponding to a window having the largest similarity in the predetermined region. coordinates acquired by adding and subtracting a predetermined value to and from the estimated coordinates around the estimated coordinates.

Further, when the depth camera has the same resolution as the plurality of cameras, the depth camera is disposed between two cameras in the array of the plurality of cameras.

Further, when the depth camera has resolution different from the plurality of cameras, the depth camera may be disposed adjacent to a camera in the array of the plurality of cameras.

Further, the method for generating a multi-viewpoint depth map may further include the step of: (b2) converting the image and depth information acquired by the depth camera into an image and depth information corresponding to the camera adjacent to the depth camera, wherein in the step (c), the coordinates may be estimated by using the converted depth information. At this time, in the step (b2), the image and depth information of the depth camera may be converted into the corresponding image and depth information by using internal and external parameters of the depth camera and the camera adjacent to the depth camera.

In order to solve a second problem, a method for generating a multi-viewpoint depth map according to the present invention includes the steps of: (a) acquiring a multi-viewpoint image constituted by a plurality of images by using a plurality of cameras; (b) acquiring an image and depth information by using a depth camera; (c) estimating coordinates of the same point in a space in the plurality of images by using the acquired depth information; and (d) determining disparities in the plurality of images with respect to in the same point by searching a predetermined region around the estimated coordinates.

In order to solve a third problem, an apparatus for generating a multi-viewpoint depth map according to the present invention includes: a first image acquiring unit acquiring a multi-viewpoint image constituted by a plurality of images by using a plurality of cameras; a second image acquiring unit acquiring an image and depth information by using a depth camera; a coordinate estimating unit estimating coordinates of the same point in a space in the plurality of images by using the acquired depth information; a disparity generating unit determining disparities in the plurality of images with respect to in the same point in a space by searching a predetermined region around the estimated coordinates; and a depth map generating unit generating a multi-viewpoint depth map by using the generated disparities.

Herein, the coordinate estimating unit may estimate disparities in the plurality of images with respect to the same point in the space from the acquired depth information and may acquire the coordinates depending on the estimated disparities.

Further, the disparity generating unit may determine the disparities by using a coordinate of a pixel corresponding to a window having the largest similarity in the predetermined region depending on similarities between pixels included in a window corresponding to the coordinate of the same point in the image acquired by the depth camera and pixels included in the window in the predetermined region.

Further, when the depth camera has the same resolution as the plurality of cameras, the depth camera may be disposed between two cameras in the array of the plurality of cameras.

Further, when the depth camera has resolution different from the plurality of cameras, the depth camera may be disposed adjacent to a camera in the array of the plurality of cameras.

Further, the apparatus for generating a multi-viewpoint depth map may further include: an image converting unit converting the image and depth information acquired by the depth camera into an image and depth information corresponding to the camera adjacent to the depth camera, wherein the coordinate estimating unit may estimate the coordinates by using the converted depth information. At this time, the image converting unit may convert the image and depth information of the depth camera into the corresponding image and depth information by using internal and external parameters of the depth camera and the camera adjacent to the depth camera.

In order to solve a fourth problem, there is provided a computer-readable recording medium where a program for executing a method for generating a multi-viewpoint depth map according to the present invention is recorded.

### ADVANTAGEOUS EFFECTS

According to the above-mentioned present invention, it is possible to generate a multi-viewpoint depth map within a shorter time and generate a multi-viewpoint depth map having higher quality than a multi-viewpoint depth map generated by using known stereo matching.

### DESCRIPTION OF DRAWINGS

FIG. 1 is a block diagram of an apparatus for generating a multi-viewpoint depth map according to an embodiment of the present invention.

FIG. 2 is a diagram for illustrating an estimation result of an initial coordinate in images by a coordinate estimating unit.

FIG. 3 is a diagram for illustrating a process in which a final disparity is determined by a disparity generating unit.

FIG. 4 is a diagram illustrating an example in which a multi-viewpoint camera included in a first image acquiring unit and a depth camera included in a second image acquiring unit are disposed according to an embodiment of the present invention.

FIG. 5 is a diagram illustrating an example in which a multi-viewpoint camera included in a first image acquiring unit and a depth camera included in a second image acquiring unit are disposed according to another embodiment of the present invention.

FIG. 6 is a block diagram of an apparatus for generating a multi-viewpoint depth map according to another embodiment of the present invention.

FIG. 7 is a conceptual diagram illustrating a process in which an image and depth information of a reference camera are converted into an image and depth information corresponding to a target camera.

FIG. 8 is flowchart of a method for generating a multi-viewpoint depth map according to another embodiment of the present invention.

FIG. 9 is a conceptual diagram illustrating a method for generating a multi-viewpoint depth map according to the embodiment of FIG. 8.

FIG. 10 is a conceptual diagram illustrating a method for generating a multi-viewpoint depth map according to the embodiment of FIG. 12.

FIG. 11 is a flowchart more specifically illustrating step S740 of FIG. 8, that is, a method for determining a final disparity according to an embodiment of the present invention.

FIG. 12 is a flowchart of a method for generating a multi-viewpoint depth map according to another embodiment of the present invention.

### MODE FOR INVENTION

Hereinafter, preferred embodiments of the present invention will be described in detail with reference to the accompanying drawings. Like reference numerals hereinafter refer to the like elements in descriptions and the accompanying drawings and thus the repetitive description thereof will be omitted. Further, in describing the present invention, when it is determined that the detailed description of a related known function or configuration may make the spirit of the present invention ambiguous, the detailed description thereof will be omitted here.

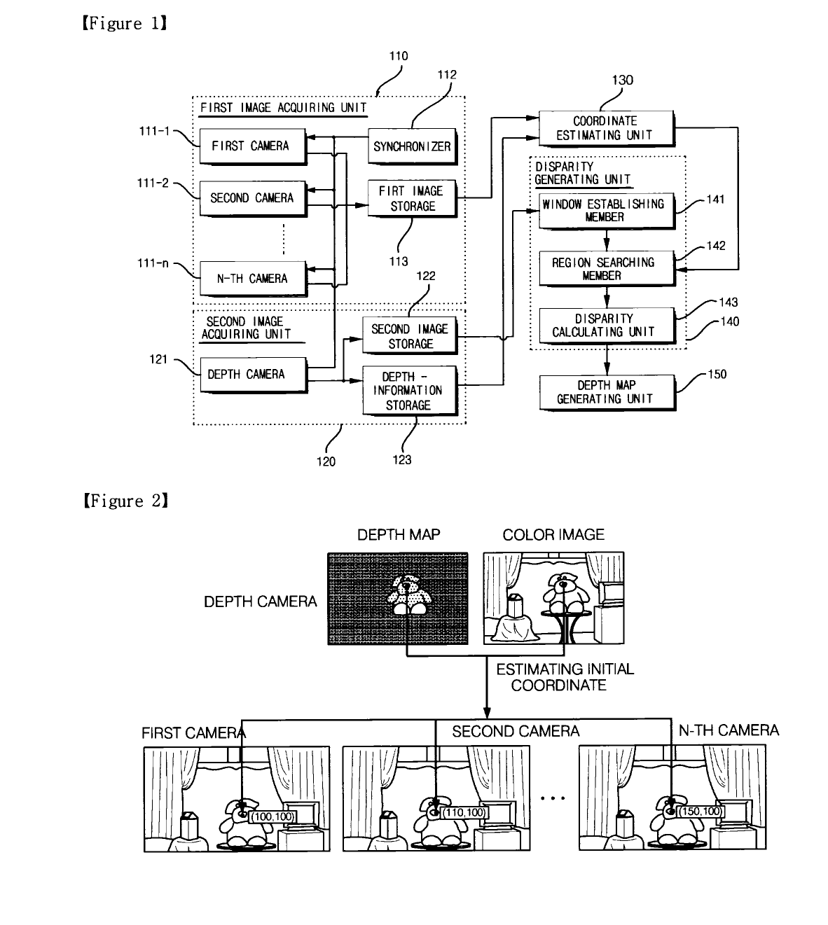

FIG. 1 is a block diagram of an apparatus for generating a multi-viewpoint depth map according to an embodiment of the present invention. Referring to FIG. 1, an apparatus for generating a multi-viewpoint depth map according to an embodiment of the present invention includes a first image acquiring unit 110, a second image acquiring unit 120, a coordinate estimating unit 130, a disparity generating unit 141, and a depth map generating unit 150.

The first image acquiring unit 110 acquires a multi-viewpoint image that is constituted by a plurality of images by using a plurality of cameras 111-1 to 111-n. As shown in FIG. 1, the first image acquiring unit 110 includes the plurality of cameras 111-1 to 111-n, a synchronizer 112, and a first image storage 113. Viewpoints formed between the plurality of cameras 111-1 to 111-n and a photographing target are different from each other depending on the positions of the cameras. As such, the plurality of images having different viewpoints are referred to as the multi-viewpoint image. The multi-viewpoint image acquired by the first image acquiring unit 110 includes two-dimensional pixel color information constituting the multi-viewpoint image, but it does not include three-dimensional depth information.

The synchronizer 112 generates successive synchronization signals to control synchronization between the plurality of cameras 111-1 to 111-n and a depth camera 121 to be described below. The first image storage 113 stores the multi-viewpoint image acquired by the plurality of cameras 111-1 to 111-n.

The second image acquiring unit 120 acquires one image and the three-dimensional depth information by using the depth camera 121. As shown in FIG. 1, the second image acquiring unit 120 includes the depth camera 121, a second image storage 122, and a depth information storage 123. Herein, the depth camera 121 throws laser beams or infrared rays on an object or a target area and acquires return beams to acquire depth information in real time. The depth camera 121 includes a color camera (not shown) that acquires an image on a color from the photographing target and a depth sensor (not shown) that senses the depth information through the infrared rays. Therefore, the depth camera 121 acquires one image containing the two-dimensional pixel color information and the depth information. Hereinafter, the image acquired by the depth camera 121 will be referred to as a second image for discrimination from the plurality of images acquired by the first image acquiring unit 110. The second image acquired by the depth camera 121 is stored in the second image storage 11 and the depth information is stored in the depth information storage 123. Physical noise and distortion may exist even in the depth information acquired by the depth camera 121. The physical noise and distortion may be alleviated by a predetermined preprocessing. A thesis on the preprocessing includes depth Video Enhancement of Haptic Interaction Using a Smooth Surface Reconstruction written by Kim Seung-man or three.

The coordinate estimating unit 130 estimates coordinates of the same point in a space in the multi-viewpoint image, that is, the plurality of images acquired by the first image acquiring unit 110 by using the second image and the depth information. In other words, the coordinate estimating unit 130 estimates coordinates corresponding to a predetermined point in the second image in the images acquired by the plurality of cameras 111-1 to 111-n with respect of the predetermined point of the second image. Hereinafter, the coordinates estimated by the coordinate estimating unit 130 are referred to as an initial coordinate for convenience.

FIG. 2 is a diagram for illustrating an estimation result of an initial coordinate in images by the coordinate estimating unit 130. Referring to FIG. 2, a depth map in which the depth information acquired by the depth camera 121 is displayed and a color image are illustrated in an upper part of FIG. 2 and color images acquired by each camera of the first image acquiring unit 110 are illustrated in a lower part of FIG. 2. In addition, initial coordinates in the cameras corresponding to one point (red color) of the color image acquired by the depth camera 121 are estimated to (100, 100), (110, 100), . . . , (150, 100).

In one embodiment of a method for the coordinate estimating unit 130 to estimate the initial coordinates, a disparity (hereinafter, an initial disparity) in the multi-viewpoint image with respect to the same point in the space is estimated and the initial coordinates can be determined depending on the initial disparity. The initial disparity may be estimated by the following equation.

$${d}_{x} = \frac{fB}{Z} \qquad [ Equation 1 ]$$

Herein, dₓ is the initial disparity, f is a focus distance of the target camera, B is a gap (baseline length) between a reference camera (depth camera) and the target camera, and Z is depth information given in a distance unit. Since the disparity represents a difference of coordinates between two images with respect to the same point in the space, the initial coordinate is determined by adding the initial disparity to the coordinate of the corresponding point in the reference camera (depth camera).

Referring back to FIG. 1, the disparity generating unit 140 determines disparities of multi-viewpoint images with respect to the same point in the space, that is, the plurality of images by searching a predetermined region around the initial coordinates estimated by the coordinate estimating unit 130. The initial coordinates or the initial disparities acquired by the coordinate estimating unit 130 are estimated based on the image and the depth information acquired by the depth camera 121. The initial coordinate or the initial disparities are similar with actual values, but they do not become accurate values. Therefore, the disparity generating unit 140 determines an accurate final disparity by searching the predetermined surrounding regions on the basis of the estimated initial coordinates.

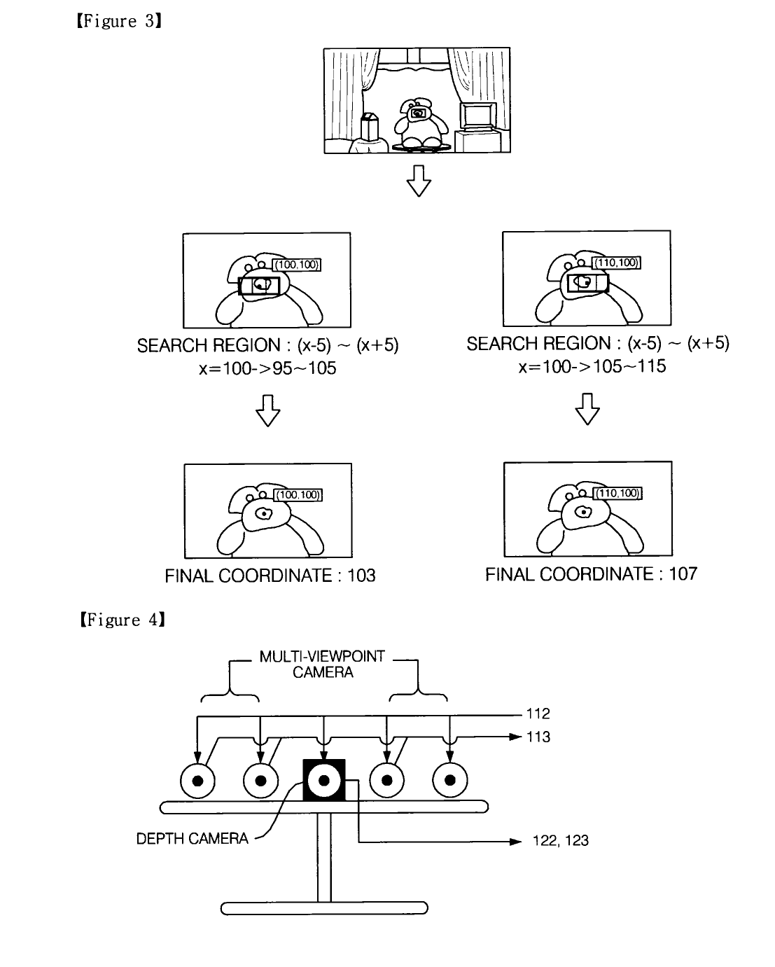

As shown in FIG. 1, the disparity generating unit 140 includes a window establishing member 141, a region searching member 142, and a disparity calculating member 143. FIG. 3 is a diagram for illustrating a process in which the final disparity is determined by the disparity generating unit 140. Hereinafter, the process will be described with reference to FIG. 3 altogether.

As shown in FIG. 3(a), the window establishing member 141 establishes a window having a predetermined size around the point with respect to a predetermined point of the second image acquired by the depth camera 121. As shown in FIG. 3(b), the region searching member 142 establishes a predetermined region around the initial coordinates estimated by the coordinate estimating unit 130 with respect to the images constituting the multi-viewpoint image as a search region. Herein, for example, the search region can be established between coordinates acquired by adding and subtracting a predetermined value to and from the initial coordinates around the estimated initial coordinates. Referring to FIG. 3(b), by setting the added or subtracted predetermined value to 5, the search region is established in the range of coordinates 95 to 105 when the initial coordinate is 100 and the search region is established in the range of the coordinates 110 to 115 when the initial coordinate is 110. A window having the same size as the window established in the second image within the search region and similarities are compared between pixels included in each window and pixels included in the window established in the second image are compared with while moving the window. Herein, for example, the similarity can be determined by comparing the pixels included in the windows with the sum of differences among the colors of the second image. A window having the largest similarity, that is, a center pixel coordinate at a position having the smallest sum of the color differences is determined as a final coordinate of a correspondence point. Referring to FIGS. 3(c), 103 and 107 are acquired for each image as the final coordinate of the correspondence point.

The disparity calculating member 143 determines a difference between a coordinate of a predetermined point in the second image and a coordinate of the acquired correspondence point as the final disparity.

Herein, for example, the search region can be established between coordinates acquired by adding and subtracting a predetermined value to and from the initial coordinates around the estimated initial coordinates. Referring to FIG. 3(b), by setting the added or subtracted predetermined value to 5, the search region is established in the range of coordinates 95 to 105 when the initial coordinate is 100 and the search region is established in the range of the coordinates 110 to 115 when the initial coordinate is 110.

Referring back to FIG. 1, the depth map generating unit 150 generates the multi-viewpoint depth map by using the disparities in the images, which is generated by the disparity generating unit 140. When the generated disparities represent dₓ, the depth value Z may be determined by using the following equation.

$$Z = \frac{fB}{{d}_{x}} \qquad [ Equation 2 ]$$

Herein, f is a focus distance of the target camera and B is a gap (baseline length) between a reference camera (depth camera) and the target camera.

FIG. 4 is a diagram illustrating an example in which the multi-viewpoint camera, that is, the plurality of cameras included in the first image acquiring unit 110 and the depth camera included in the second image acquiring unit 120 are disposed according to an embodiment of the present invention. When the multi-viewpoint camera has the same resolution as the depth camera, it is preferable that the multi-viewpoint camera and the depth camera are lined up and the depth camera is preferably disposed between two cameras in the multi-viewpoint camera array, as shown in FIG. 1. When the multi-viewpoint camera has the same resolution as the depth camera, both the multi-viewpoint camera and the depth camera may have SD-class resolution, HD-class resolution, and UD-class resolution.

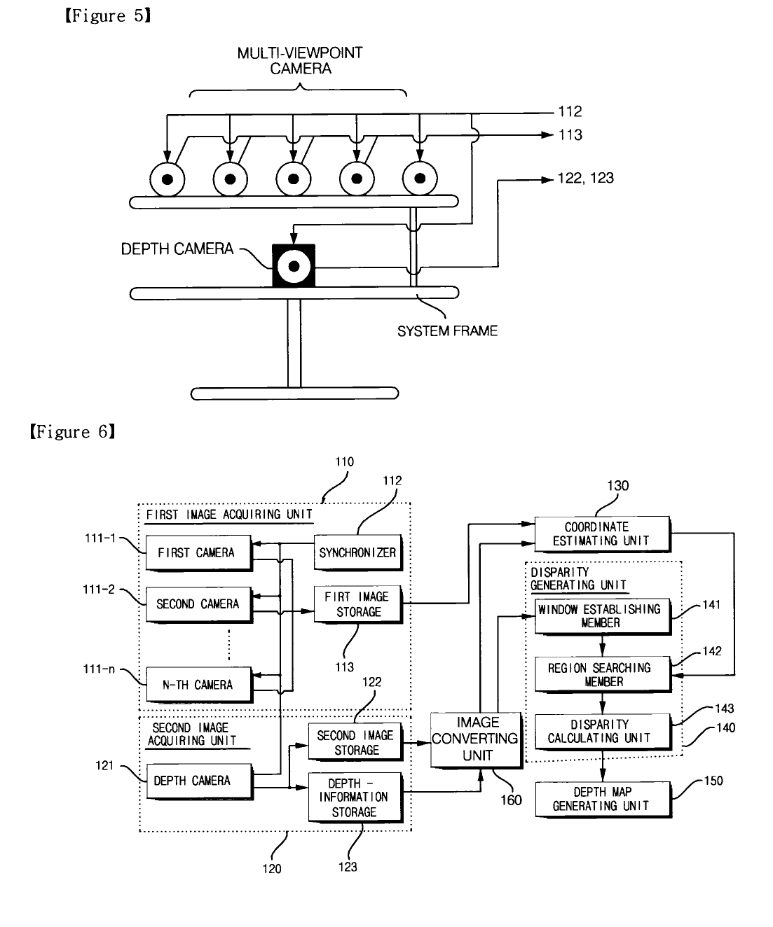

FIG. 6 is a block diagram of an apparatus for generating a depth map according to another embodiment of the present invention and is applied when the multi-viewpoint camera has resolution different from the depth camera, as an example. When the multi-viewpoint camera have resolution different from the depth camera, the multi-viewpoint camera and the depth camera may have HD and SD-class resolutions, UD and SD-class resolutions, and UD and HD-class resolution, respectively, as an example. In the case of the embodiment, it is preferable that the depth camera and the multi-viewpoint camera are not lined up as shown in FIG. 4, but the depth camera is disposed adjacent to a camera positioned in the array of the plurality of cameras. FIG. 5 is a diagram illustrating an example in which the multi-viewpoint camera 121 included in the first image acquiring unit 110, that is, the plurality of cameras 111-1 to 111-n and the depth camera included in the second image acquiring unit 120 are disposed according to another embodiment of the present invention. Referring to FIG. 5, the plurality of cameras included in the first image acquiring unit 110 are lined up and the depth camera may be disposed at a position adjacent to the middle camera, for example, below the middle camera. Further, the depth camera may also be disposed above the middle camera.

As compared with FIG. 1, constituent components except for an image converting unit 160 which is a constituent component newly added in FIG. 6 have been already described in FIG. 1. Therefore, the description thereof will be omitted. In this embodiment, since the depth camera 121 has resolution different from the plurality cameras 111-1 to 111-n, a coordinate cannot be estimated directly by using the depth information acquired by the depth camera. Therefore, the image converting unit 160 converts the image and depth information acquired by the depth camera 121 into an image and depth information corresponding to a camera adjacent to the depth camera 121. Herein, for convenience of description, the camera adjacent to the depth camera 121 will be referred to as ‘adjacent camera’. From the conversion result, the image acquired by the depth camera 121 matches the image acquired by the adjacent camera each other. As a result, an image and depth information to have been acquired if the depth camera is disposed at the position of the adjacent camera are acquired. The conversion can be performed by scaling the acquired image in consideration of a difference in resolution between the depth camera and the adjacent camera and warping the scaled image by using internal and external parameters of the depth camera 121 and the adjacent camera.

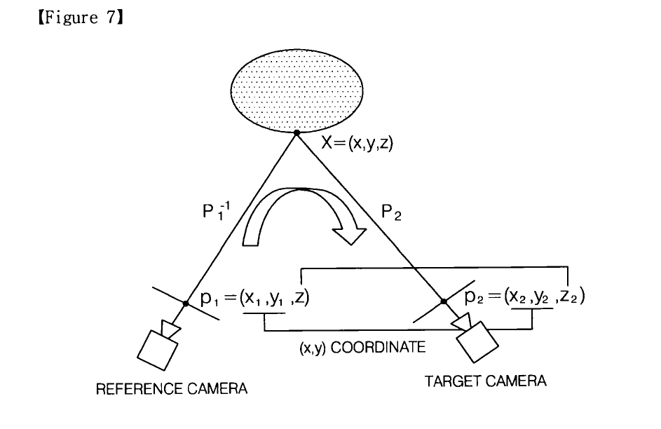

FIG. 7 is a conceptual diagram illustrating a process in which the image and depth information acquired by the depth camera 121 are converted into the image and depth information corresponding to the adjacent camera by warping. The cameras generally have camera's peculiar characteristics, i.e., the internal parameters and the external parameters. The internal parameters include the focus distance of the camera and a coordinate of an image center point and the external parameters include camera's own translation and rotation with respect to other cameras.

A base matrix Pₙ of the camera depending on the internal parameters and the external parameters is acquired by the following equation.

$${P}_{n} = [ \begin{matrix}{P}_{00} & {P}_{01} & {P}_{02} & {P}_{03} \\ {P}_{10} & {P}_{11} & {P}_{12} & {P}_{13} \\ {P}_{20} & {P}_{21} & {P}_{22} & {P}_{23}\end{matrix} ] = [ \begin{matrix}{K}_{x} & 0 & {P}_{x} \\ 0 & {K}_{y} & {P}_{y} \\ 0 & 0 & 1\end{matrix} ] = [ \begin{matrix}{R}_{00} & {R}_{01} & {R}_{02} & {T}_{x} \\ {R}_{10} & {R}_{11} & {R}_{12} & {T}_{y} \\ {R}_{20} & {R}_{21} & {R}_{22} & {T}_{z}\end{matrix} ] \qquad [ Equation 3 ]$$

Herein, a first matrix at the right side is constituted by the internal parameters and a second matrix at the right side is constituted by the external parameters.

As shown in FIG. 7, when coordinate/depth values in the reference camera (depth camera) and the target camera (adjacent camera) with respect to the same point in the space are set to p₁(x₁, y₁, z₁) and p₂(x₂, y₂, z₂), respectively, the coordinate in the target camera can be acquired by the following equation.

p₂=P₂·P₁⁻¹·p₁ [Equation 4]

That is, the coordinate and the depth value in the target camera can be acquired by multiplying a reverse matrix of a base matrix of the reference camera and a base matrix of the target camera by the coordinate/depth value of the reference camera. As a result, the image and depth information corresponding to the adjacent camera are acquired.

In this embodiment, the coordinate estimating unit 130 estimates coordinates of the same point in the space in the multi-viewpoint image, that is, the plurality of images acquired by the first image acquiring unit 110 by using the image and depth information converted by the image converting unit 160, as described relating to FIG. 1. Further, an image as a criterion for establishing the window in the window establishing member 141 also becomes the image converted by the image converting unit 160.

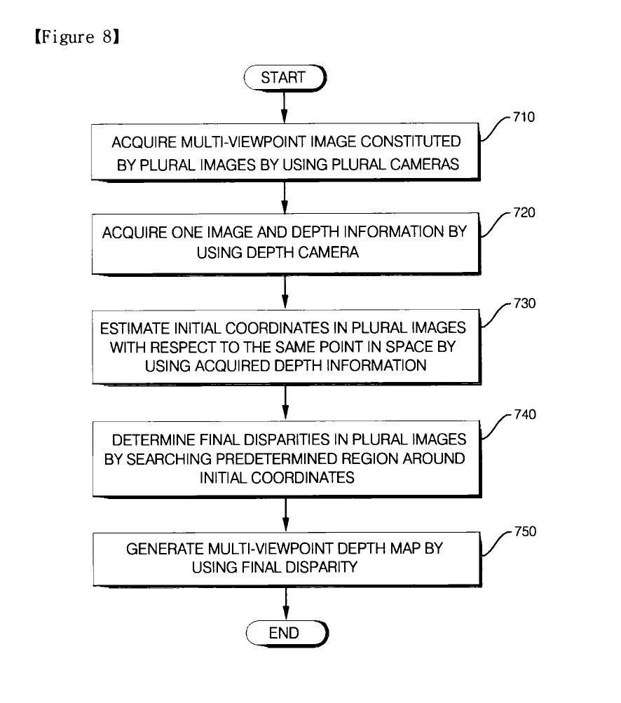

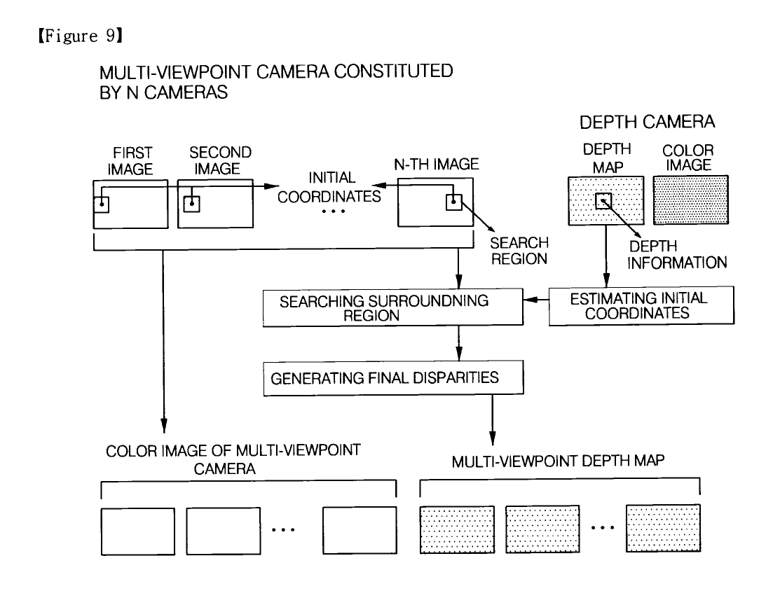

FIG. 8 is a flowchart of a method for generating a multi-viewpoint depth map according to an embodiment of the present invention and a flowchart when the depth camera has the same resolution as the multi-viewpoint camera. FIG. 9 is a conceptual diagram illustrating a method for generating a multi-viewpoint depth map according to this embodiment. The method for generating the multi-viewpoint depth map according to this embodiment includes steps processed by the apparatus for generating the multi-viewpoint depth map described relating to FIG. 1. Therefore, even though omitted hereafter, contents described relating to FIG. 1 are also applied to the method for generating the multi-viewpoint depth map according to this embodiment.

The apparatus for generating the multi-viewpoint depth map acquires the multi-viewpoint image constituted by the plurality of images by using the plurality of cameras in step S710 and acquire one image and depth information by using the depth camera in step S720.

Further, in step S730, the apparatus for generating the multi-viewpoint depth map estimates the initial coordinates in the plurality of images acquired in step S710 with respect to the same point in the space by using the depth information acquired in the step S720.

In step S740, the apparatus for generating the multi-viewpoint depth map searches a predetermined region adjacent to the initial coordinates estimated in step S730 to determine the final disparities in the plurality of images acquired in step S710.

In step S750, the apparatus for generating the multi-viewpoint depth map generates the multi-viewpoint depth map by using the final disparities determined in step S740.

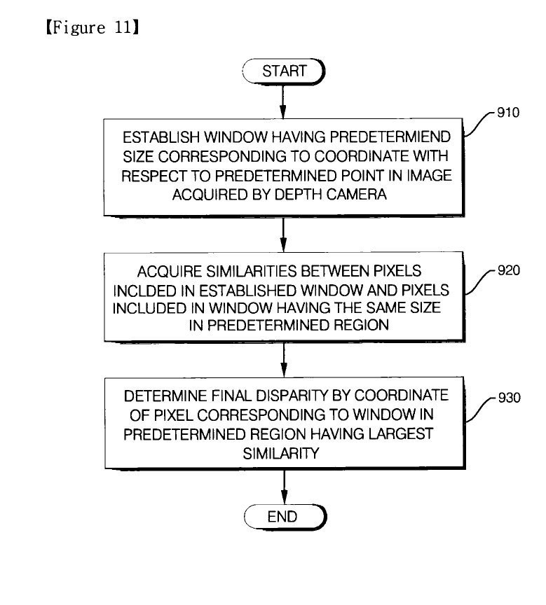

FIG. 11 is a flowchart more specifically illustrating step S740 of FIG. 8, that is, a method for determining the final disparity according to an embodiment of the present invention. The method according to the embodiment includes steps processed by the disparity generating unit 140 of the apparatus for generating the multi-viewpoint depth map, which are described relating to FIG. 1. Therefore, even though omitted hereafter, contents described relating to the disparity generating unit 140 of FIG. 1 are also applied to a method for determining the final disparities according to this embodiment.

In step S910, a window having a predetermined size, which corresponds to a coordinate of a predetermined point in the image acquired by the depth camera is established.

In step S920, similarities are acquired between pixels included in the window established in step S910 and pixels included in windows having the same size in a predetermined region adjacent to an initial coordinate.

In step S930, a coordinate of a pixel corresponding to the window having the largest similarity among the windows in the predetermined region adjacent to the initial coordinate is acquired as the final coordinate and a final disparity is acquired by using the final coordinate.

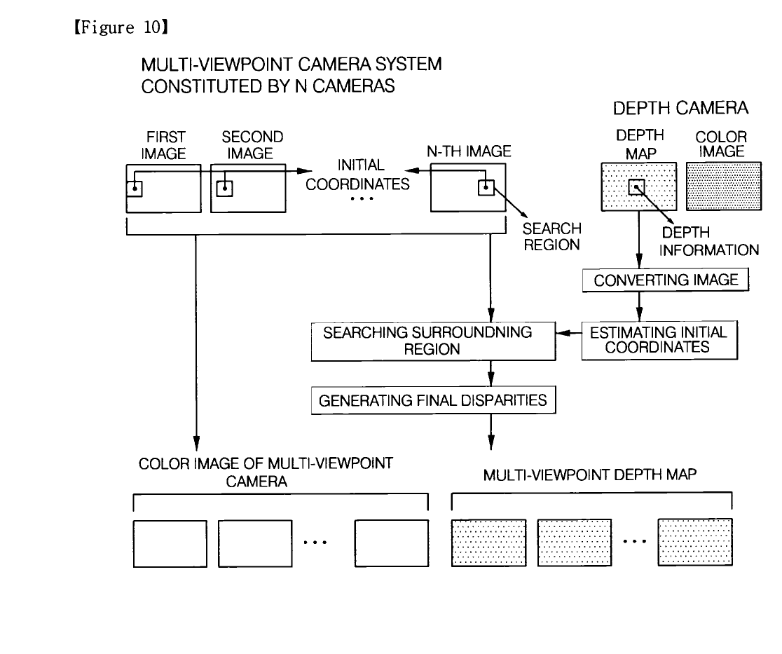

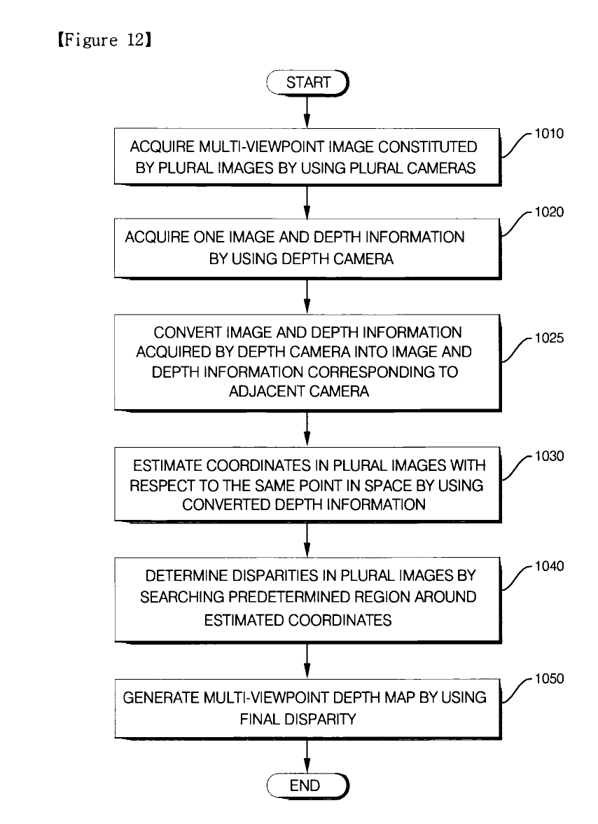

FIG. 12 is a flowchart of a method for generating a multi-viewpoint depth map according to another embodiment of the present invention and a flowchart when the depth camera has resolution different from the multi-viewpoint camera. FIG. 10 is a conceptual diagram illustrating a method for generating a multi-viewpoint depth map according to this embodiment. The method for generating the multi-viewpoint depth map according to this embodiment includes steps processed by the apparatus for generating the multi-viewpoint depth map described relating to FIG. 6. Therefore, even though omitted hereafter, contents described relating to FIG. 6 are also applied to the method for generating the multi-viewpoint depth map according to this embodiment.

Meanwhile, since steps S1010, S1020, S1040, and S1050 which are described in FIG. 12 are the same as steps S710, S720, S740, and S750 which are described in FIG. 8, the description thereof will be omitted.

Next to step S1020, in step S1025, the apparatus for generating the multi-viewpoint depth map converts the image and depth information acquired by the depth camera into the image and depth information corresponding to the camera adjacent to the depth camera.

In step S1030, the apparatus for generating the multi-viewpoint depth map estimates coordinates in the plurality of images with respect to the same point in the space by using the depth information converted in step S1025.

Further, a detailed embodiment of step S1040 described in this embodiment are substantially the same as that shown in FIG. 11. However, the reference image for establishing the window in step S910 is not the image acquired by the depth camera, but the window is established in the image converted in step S1025.

According to the present invention, since the disparity is determined by searching only a predetermined region based on the initial coordinate estimated with respect to the same point in the space, it is possible to generate the multi-viewpoint depth map within a shorter time. Further, since the initial coordinate is estimated by using accurate depth information acquired by the depth camera, it is possible to generate a multi-viewpoint depth map having higher quality than a multi-viewpoint depth map generated by using known stereo matching. Further, when the depth camera has resolution different from the multi-viewpoint camera, the image and depth information of the depth camera are converted into the image and depth information corresponding to the camera adjacent to the depth camera and the initial coordinate is estimated based on the converted depth information and image. As a result, even though the depth camera has resolution different from the multi-viewpoint camera, it is possible to generate a multi-viewpoint depth map having the same resolution as the multi-viewpoint camera.

Meanwhile, the above-mentioned embodiments of the present invention can be prepared by a program executed in a computer and implemented by a universal digital computer that operates the program by using computer-readable recording media. The computer-readable recording media include magnetic storage media (i.e., a ROM, a floppy disk, a hard disk, etc.), optical reading media (i.e., a CD-ROM, a DVD, etc.), and a storage medium such as a carrier wave (i.e., transmission through the Internet).

Up to now, preferred embodiments of the present invention have been described. It will be appreciated by those skilled in the art that various modifications can be made without departing from the scope and sprit of the present invention. Therefore, the above-mentioned embodiments should be considered not from a limitative viewpoint but a descriptive viewpoint. The scope of the present invention has been described not in the above description, but in the appended claims. It should be appreciated that all differences within the scope equivalent thereto are included in the present invention.

### INDUSTRIAL APPLICABILITY

The present invention relates to processing a multi-viewpoint image and is industrially available.

1. A method for generating a multi-viewpoint depth map, comprising the steps of:
(a) acquiring a multi-viewpoint image constituted by a plurality of images by using a plurality of cameras;
(b) acquiring an image and depth information by using a depth camera;
(c) estimating coordinates of the same point in a space in the plurality of images by using the acquired depth information;
(d) determining disparities in the plurality of images with respect to in the same point by searching a predetermined region around the estimated coordinates; and
(e) generating a multi-viewpoint depth map by using the determined disparities.

2. The method for generating a multi-viewpoint depth map according to claim 1, wherein in the step (b), the disparities in the plurality of images with respect to the same point in the space are estimated from the acquired depth information and the coordinates are acquired depending on the estimated disparities.

3. The method for generating a multi-viewpoint depth map according to claim 2, wherein the disparities are estimated by the following equation:
$${d}_{x} = \frac{fB}{Z}$$
where, dₓ is the disparity, f is a focus distance of a corresponding camera among the plurality of cameras, B is a gap between the corresponding camera and the depth camera, and Z is the depth information.

4. The method for generating a multi-viewpoint depth map according to claim 1, wherein the step (d) includes the steps of:
(d1) establishing a window having a predetermined size, which corresponds to the coordinate with respect to the same point in the image, which is acquired by the depth camera;
(d2) acquiring similarities between pixels included in the window having the predetermined size and pixels included in windows having the same size in the predetermined region; and
(d3) determining the disparities by using the coordinates of the pixels corresponding to a window having the largest similarity in the predetermined region.

5. The method for generating a multi-viewpoint depth map according to claim 1, wherein the predetermined region is decided depending on coordinates acquired by adding and subtracting a predetermined value to and from the estimated coordinates around the estimated coordinates.

6. The method for generating a multi-viewpoint depth map according to claim 1, wherein when the depth camera has the same resolution as the plurality of cameras, the depth camera is disposed between two cameras in the array of the plurality of cameras.

7. The method for generating a multi-viewpoint depth map according to claim 1, wherein when the depth camera has resolution different from the plurality of cameras, the depth camera is disposed adjacent to a camera in the array of the plurality of cameras.

8. The method for generating a multi-viewpoint depth map according to claim 7, further comprising the step of:
(b2) converting the image and depth information acquired by the depth camera into an image and depth information corresponding to the camera adjacent to the depth camera,
wherein in the step (c), the coordinates are estimated by using the converted depth information.

9. The method for generating a multi-viewpoint depth map according to claim 8, wherein in the step (b2), the image and depth information of the depth camera are converted into the corresponding image and depth information by using internal and external parameters of the depth camera and the camera adjacent to the depth camera.

10. A computer-readable recording medium where a program for executing a method for generating a multi-viewpoint depth map according to claim 1

11. A method for generating a multi-viewpoint depth map, comprising the steps of:
(a) acquiring a multi-viewpoint image constituted by a plurality of images by using a plurality of cameras;
(b) acquiring an image and depth information by using a depth camera;
(c) estimating coordinates of the same point in a space in the plurality of images by using the acquired depth information; and
(d) determining disparities in the plurality of images with respect to in the same point by searching a predetermined region around the estimated coordinates.

12. An apparatus for generating a multi-viewpoint depth map, comprising:
a first image acquiring unit acquiring a multi-viewpoint image constituted by a plurality of images by using a plurality of cameras;
a second image acquiring unit acquiring an image and depth information by using a depth camera;
a coordinate estimating unit estimating coordinates of the same point in a space in the plurality of images by using the acquired depth information;
a disparity generating unit determining disparities in the plurality of images with respect to in the same point in a space by searching a predetermined region around the estimated coordinates; and a depth map generating unit generating a multi-viewpoint depth map by using the generated disparities.

13. The apparatus for generating a multi-viewpoint depth map according to claim 12, wherein the coordinate estimating unit estimates disparities in the plurality of images with respect to the same point in the space from the acquired depth information and acquires the coordinates depending on the estimated disparities.

14. The apparatus for generating a multi-viewpoint depth map according to claim 13, wherein the disparities are estimated by using the following equation:
$${d}_{x} = \frac{fB}{Z}$$
where, dₓ is the disparity, f is a focus distance of a corresponding camera among the plurality of cameras, B is a gap between the corresponding camera and the depth camera, and Z is the depth information.

15. The apparatus for generating a multi-viewpoint depth map according to claim 12, wherein the disparity generating unit determines the disparities by using a coordinate of a pixel corresponding to a window having the largest similarity in the predetermined region depending on similarities between pixels included in a window corresponding to the coordinate of the same point in the image acquired by the depth camera and pixels included in the window in the predetermined region.

16. The apparatus for generating a multi-viewpoint depth map according to claim 12, wherein the predetermined region is decided depending on coordinates acquired by adding and subtracting a predetermined value to and from the estimated coordinates around the estimated coordinates.

17. The apparatus for generating a multi-viewpoint depth map according to claim 12, wherein when the depth camera has the same resolution as the plurality of cameras, the depth camera is disposed between two cameras in the array of the plurality of cameras.

18. The apparatus for generating a multi-viewpoint depth map according to claim 12, wherein when the depth camera has resolution different from the plurality of cameras, the depth camera is disposed adjacent to a camera in the array of the plurality of cameras.

19. The apparatus for generating a multi-viewpoint depth map according to claim 18, further comprising:
an image converting unit converting the image and depth information acquired by the depth camera into an image and depth information corresponding to the camera adjacent to the depth camera,
wherein the coordinate estimating unit estimates the coordinates by using the converted depth information.

20. The apparatus for generating a multi-viewpoint depth map according to claim 19, wherein the image converting unit converts the image and depth information of the depth camera into the corresponding image and depth information by using internal and external parameters of the depth camera and the camera adjacent to the depth camera.
